(19) United States
(12) Patent Application Publication
(10) Pub. No.: US 2010/0063945 A1
(43) Pub. Date: Mar. 11, 2010

(54) Systems and Methods Involving Processing of Payments Using Handheld Devices

(76) Inventor: William Curtis Cowan, JR., Memphis, TN (US)

Correspondence Address: Adams and Reese LLP, 1221 McKinney Street, Suite 4400, Houston, TX, 77010, US

(21) Appl. No.: 12/617,371

(22) Filed: Nov. 12, 2009

Related U.S. Application Data
(60) Provisional application No. 61/113,673, filed on Nov. 12, 2008.

(51) Int. Cl. G06Q 90/00

(52) U.S. Cl. 705/500

(57) ABSTRACT

Embodiments of the invention provide systems and methods for allowing merchants to perform remote credit card transactions by facilitating non-CNP transactions via a package delivery service. A non-CNP transaction includes a credit card transaction where the card is physically presented to the merchant and a receipt may be signed. Various embodiments may also include transactions in which an imprint of the card is taken.

### CROSS-REFERENCE TO RELATED APPLICATIONS

The present invention claims the benefit of prior U.S. provisional application No. 61/113,673 filed Nov. 12, 2008.

### FIELD OF INVENTION

The present invention relates generally to transactions using handheld devices, and in a particular though non-limiting embodiment, to systems and methods to reduce transaction fees and the risks of fraud when accepting payment cards.

### BACKGROUND

“Card Not Present” (CNP) transactions are typically transactions where a remitter cannot physically present a credit card to a merchant and sign a receipt. Generally, this occurs when transactions are remotely arranged by telephone, fax, email or online commerce systems. However, there may be situations where a physically presented credit card creates a CNP transaction, such as if a merchant experiences an equipment failure. Because current credit card processing systems were originally designed for face-to-face transactions, CNP transactions are, despite their increasing prevalence, treated as exceptions to standard transactions and special rules are applied to them. Particularly, the growth of CNP transactions, fueled by the online commerce boom, has led to increasing merchant dissatisfaction because (1) CNP transactions are more expensive to process through acquirers, (2) many consumers fear giving out credit card numbers for CNP transactions, and (3) merchants are liable for fraudulent charges rather than the issuing bank that approved the transaction.

Today, merchants are penalized ½ of 1% of a CNP transaction by credit card networks. Further penalties are assessed by various banking and financial institutions and include penalties for “qualification downgrades” which occur when processing CNP transactions. For example, after inputting a card number and expiration date, merchants are often prompted for additional verification information that is later matched with stored data within systems of credit card networks, such as a financial institution's card verification code, zip code or street address.

Mismatches are very common during the described process. For example, if a cardholder's billing address is a post office box rather than a street address and the zip code varies from that input by the merchant, two mismatches can be created which lead to the transaction downgraded from “qualified” status to “partially qualified” or worse, “unqualified” status which accrues the greatest penalties. Merchants are often unable to control these downgrades which, when added to other upstream fees, can result in a merchant paying the acquirer as much as 5% of a transaction or more for processing.

Downgrade rules and credit card billing statements can be very difficult to understand for those who aren't intricately trained. Financial institutions commonly take advantage of merchant ignorance by quoting low processing fees to undercut their competitors and make up their losses through downgrade penalties. Thus, the competitive tactics and high processing fees generate great merchant dissatisfaction with financial institutions and the credit card industry in general.

In the world of online commerce, it is commonly claimed that the number one reason Internet users give for not shopping online is their fear of giving out credit card numbers and additional verification details over the Internet. For merchants engaged in CNP transactions arising from the more traditional but less widely tracked Mail Order/Telephone Order (MOTO) sales processes, it follows that what is true for online commerce similarly applies to them. That is, if someone won't input their card information into a website, they may be less likely to give it to a merchant employee who could more conceivably misuse it. Thus, fear of fraud by cardholders hurts sales for merchants who rely upon CNP transactions.

For CNP transactions and swiped transactions, merchants are liable for fraudulent charges rather than the issuing bank that approved the transaction. The phenomenal growth of online sales, where CNP is the norm, has been accompanied by a corresponding growth in credit card fraud. In 2007, $3.6 billion in losses to such fraud was reported in the United States and Canada by online merchants alone, MOTO merchants and other CNP transaction originators not included. Merchants operating in CNP environments encounter two types of fraud. “Deliberate Fraud” results from stolen or fabricated credit cards and card numbers. “Friendly Fraud” transactions are those in which valid credit cards are used by their cardholders in ways that might take advantage of merchants. Friendly fraud is very common but is less well understood, harder to pinpoint and is largely not included in the fraud figures above. It occurs when a merchant's customer disputes a merchant's legitimate charge. For example, a husband might make a charge online and later deny the charge to his wife who, in turn, may then call the card issuer and dispute the merchant's bill which may result in a chargeback to the merchant. Similarly, when customers claim non-receipt of goods, non-arrival of goods due to incorrect shipping address or goods refused upon delivery, a chargeback may be incurred even though there may have been fraudulent intent on the part of the customer. Merchants can fight chargebacks but find that it often isn't worth the effort.

Merchants who accept credit cards face increasing challenges to their profitability from utilizing existing and available credit card processing systems and services. Direct losses from fraudulent charges have skyrocketed in recent years as have indirect losses from merchant fear of fraud. Losses to merchants from CNP transaction fraud include loss of payments, merchandise and shipping fees, loss from chargeback fees and fines. The fees and fines encourage merchants to forgo challenging fraudulent transactions. As described, the CNP transaction environment has proven inadequate for meeting the needs of merchants. With the exponential number of factors opposing CNP transactions, incremental improvements will not prove to be t enough. A method in needed that allows merchants to avoid CNP transactions entirely by performing non-CNP transactions remotely.

### BRIEF DESCRIPTION OF THE DRAWINGS

FIG. 1 is a flow diagram of a method of processing payments using a handheld device.

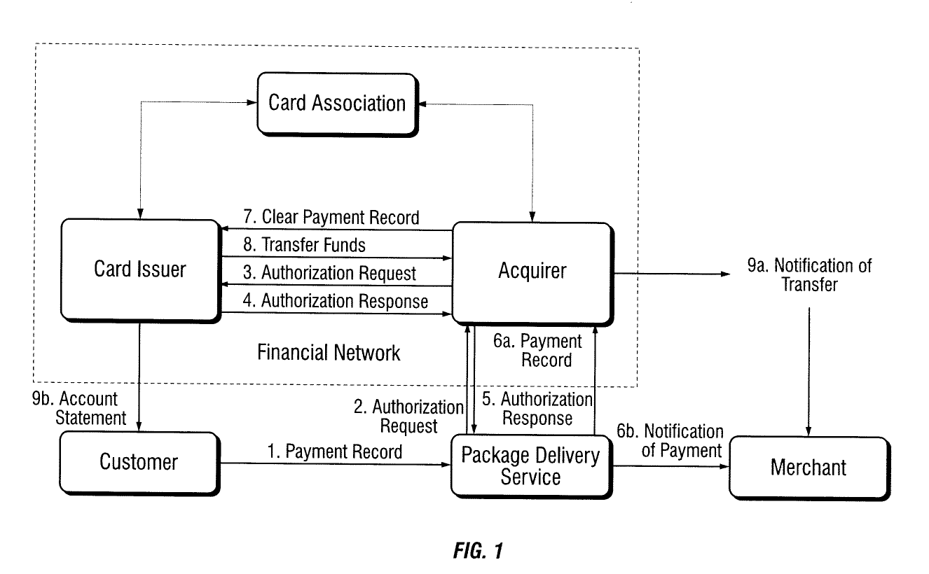

### DETAILED DESCRIPTION

Embodiments of this invention provide systems and methods for allowing merchants to perform remote credit card transactions by facilitating non-CNP transactions via a package delivery service. A non-CNP transaction includes a credit card transaction that is not a CNP transaction, which means the card is physically presented to the merchant and a receipt may be signed. Various embodiments also include transactions in which an imprint of the card is taken.

In some embodiments, a delivery courier physically visits a credit card remitter, requests a credit card for payment on behalf of the merchant, swipes the credit card through a handheld device and completes the transaction just as the merchant would process a payment using a credit card terminal. If a package is associated with the transaction, the package is released upon transaction approval.

In one embodiment, the delivery service acts as a supplemental credit card terminal for the merchant through a website, a computer system, package delivery couriers and the couriers' wireless handheld devices and systems. In other embodiments, the package delivery service's systems imitate a merchant's credit card terminal when a request for authorization is electronically sent by a courier device. Upon authorization retrieval, typical embodiments authorize the merchant to receive funds, not the delivery service. Further, the merchant has achieved a non-CNP transaction and avoided many of the objections to CNP transactions detailed above.

Embodiments are designed as a service offered by a delivery service to its customers and potential customers. In typical embodiments, a majority of the work is be done by the delivery service with the result that it can be offered in the marketplace as a “plug-in” solution that works with the existing credit card industry and merchant practices and will not require, for the most part, these industries to alter practices to accommodate the invention.

Additional embodiments include but are not limited to:
a) Processes enabled by the package delivery carrier itself becoming an acquirer and processing credit card transactions for merchants.
b) Processes to automate functions of the credit card terminal using a delivery carrier's systems and devices.
c) Processes to facilitate cancellation of a prior credit card authorization when the related transaction is processed on the courier's device.
d) Processes to facilitate conversion of a prior credit card authorization into a non-CNP transaction at the non-CNP transaction rate if allowable.
e) Processes to facilitate cancellation or conversion of a prior credit card authorization by swiping either the same credit card or an entirely different card and still achieve a single transaction with the merchant's acquirer for purposes of fees charged to the merchant.
f) Processes that enable the package delivery carrier to forward or cause to be forwarded additional payment from merchant to another party such as merchant's vendor when transaction is completed or when funds are made available to merchant
g) Processes that may be enabled as the merchants and acquirers evolve to utilize the package delivery service's capability to perform remote credit card transactions by facilitating Swiped transactions.

Typical embodiments require modification and appropriate computer instructions written on a delivery carrier's website to allow: (a) a merchant to input information as he would if he were setting up a new credit card terminal and (b) information about the credit card transaction to be input alongside and associated with package shipping information or, in the event of a payment not affiliated with a package to be shipped, absent that information (although there is certainly overlap between the required information, package or no package). In further embodiments, dispatch systems are modified appropriate computer instructions written to facilitate payment transactions without associated deliveries and enable same day payments to be requested by merchants. In still further embodiments, appropriate computer instructions will need to be written to allow delivery carrier's computer systems to accept input from their couriers' devices and connect to financial institutions to process the transactions similar to a credit card terminal.

Delivery service couriers currently utilize wireless handheld devices that employ operating software, signature capture screens and effective wireless communications systems. Such devices can be converted to remote credit card terminals by retrofitting a magnetic card swiper and a small receipt printer or by a similar method. Alternatively, separate wireless devices with credit card features are employed in some embodiments to communicate with the courier's existing devices and/or supporting communications systems. In other embodiments, programming is required to accept credit card input and conduct typical credit card terminal functions.

### Exemplary Operation(s)

In one embodiment, a merchant sets up an account with a delivery service and inputs information into the website as he would when programming a new credit card terminal. When a payment is needed from a credit card holder, the merchant inputs information about the payment needed and related package delivery information. In several embodiments, the merchant may subsequently request an authorization on the card holder's credit card for the full payment amount or a partial amount. This authorization may be requested through the delivery carrier's systems or another credit card terminal used by the merchant.

In further embodiments, the delivery carrier dispatches a courier to the site of the credit card holder and asks for a credit card for payment, giving the card holder the total amount of the charge and any other information the card holder needs. As an agent for the merchant, the delivery courier may be required by the merchant's card processing agreement to follow additional steps such as checking the card against a valid ID or comparing the signature on the card to the signature captured. In still further embodiments, the courier swipes the card through the device and a data is transported through the package delivery service's communications systems and goes to the merchant's acquirer. The data goes upstream to get approved by the credit card issuer and this approval is then forwarded back to the package delivery service's computer system which sends it on to their courier's device or devices.

In some embodiments, if the transaction is authorized, a signature is collected on the signature pad of one of the devices and a receipt in the name of the merchant is printed out or forwarded elsewhere such as to an email account or fax number. In other embodiments, if the transaction is declined, the courier can ask for another card or follow instructions forwarded to the courier that come from the merchant. Successful and unsuccessful transactions result in information, including any captured signature, being transmitted back to merchant's account and accessible on the website or other systems merchant may use. Such information allows the merchant to see clearance of the transaction and funds being made available just as he would when he totals out his receipts on a credit card terminal.

While the embodiments are described with reference to various implementations and exploitations, it will be understood that these embodiments are illustrative and that the scope of the invention(s) is not limited to them. In general, embodiments of a bag grasping device as described herein may be implemented using methods, facilities, and devices consistent with any appropriate structural or mechanical system(s). Many variations, modifications, additions, and improvements are possible.

For example, plural instances may be provided for components, operations or structures described herein as a single instance. Other allocations of functionality are envisioned and will also fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements also fall within the scope of the inventive subject matter without departing from the spirit thereof.

1. A method of processing payments using a handheld device, the method comprising:
processing non-CNP transactions using a device provided by a package delivery service.
